(19) United States
(12) Patent Application Publication
(10) Pub. No.: US 2023/0370437 A1
(43) Pub. Date: Nov. 16, 2023

(54) METHOD FOR COMMUNICATION BETWEEN ELECTRONIC DEVICES AND SYSTEM FOR COMMUNICATION BETWEEN ELECTRONIC DEVICES

(71) Applicant: ASVIN GMBH, Stuttgart (DE)

(72) Inventor: Mirko ROSS, Wangen (DE)

(73) Assignee: ASVIN GMBH, Stuttgart (DE)

(21) Appl. No.: 18/227,730

(22) Filed: Jul. 28, 2023

Related U.S. Application Data
(63) Continuation of application No. PCT/EP2021/052176, filed on Jan. 29, 2021.

(51) Int. Cl. H04L 9/40

(52) U.S. Cl. CPC H04L 63/0428; H04L 63/105

(57) ABSTRACT

The invention relates to a method for communication between electronic devices, by means of which method electronic devices can communicate with each other simply and securely, said method comprising the following: providing a first electronic device; providing a second electronic device, wherein a) the first electronic device determines security data of the second electronic device on the basis of an encrypted device data set of the second electronic device; and/or b) the second electronic device determines security data of the first electronic device on the basis of an encrypted device data set of the first electronic device.

### CROSS-REFERENCE TO RELATED APPLICATIONS

This application is a continuation of PCT International Application No. PCT/EP2021/052176 filed on Jan. 29, 2021, which is incorporated herein by reference in its entirety and for all purposes.

### FIELD OF DISCLOSURE

The present invention relates to a method for communication between electronic devices.

### BACKGROUND

The number of electronic devices which communicate with one another, that is to say the interlinking of electronic devices, is steadily increasing.

In the case of electronic devices which communicate with one another, for example, in the Internet of Things (IoT), a communication connection is often established automatically.

Even with large networks, a communication connection in some cases only needs to be established once, wherein a wide variety of electronic devices from different manufacturers communicate with one another. In particular, electronic devices of different ages and with different software and/or firmware versions are also used here.

In the case of an automatic establishment of a communication connection between these electronic devices, there are considerable security risks, since an insecure electronic device can be used, for example, by malware as an entry gate into an entire network.

### SUMMARY OF THE INVENTION

The object of the present invention is to provide a method for communication between electronic devices, by means of which electronic devices can communicate easily and securely with one another.

This object is achieved according to the invention by a method for communication between electronic devices having the features of claim 1.

The method is preferably suitable for communication between two or more than two electronic devices.

The method preferably comprises the following:
providing a first electronic device;
providing a second electronic device, wherein
a) the first electronic determines security data of the second electronic device on the basis of an encrypted device data set of the second electronic device; and/or
b) the second electronic device determines security data of the first electronic device on the basis of an encrypted device data set of the first electronic device.

Within the scope of this description and of the appended claims, it is also conceivable in principle for more than two electronic devices to be used.

It is thus preferably conceivable for the method to be carried out for more than two electronic devices, for example for three, four, five or more than five electronic devices.

Designation as a “first electronic device” and as a “second electronic device” is therefore preferably used in the context of this description and the appended claims for distinguishing between two electronic devices.

The term “in particular” is used in the context of this description and the appended claims for describing optional and/or non-mandatory features.

In one embodiment of the method, it is provided that
a) the first electronic device establishes a communication connection with the second electronic device when security data of the second electronic device lie within a prespecified value range and/or exceed a prespecified limit value; and/or
b) the second electronic device establishes a communication connection with the first electronic device when security data of the first electronic device lie within a prespecified value range and/or exceed a prespecified limit value.

The communication connection is, for example, a peer-to-peer (P2P) communication connection.

Alternatively, it is conceivable that the communication connection is a client-server communication connection.

It can also be advantageous if the communication connection is a meshed network communication connection.

The communication connection is preferably a wireless communication connection.

The wireless communication connection preferably comprises a communication according to one or more of the following communication standards:
a mobile radio standard;
a WLAN (wireless local area network) standard;
a long-range wide area network (LoRaWAN) standard;
a narrowband Internet of Things (NB-IoT) standard;
a Bluetooth standard;
a Zigbee standard;
an NFC standard.

A direct communication connection between the first electronic device and the second electronic device is, for example, a peer-to-peer connection.

In one embodiment of the method, it is provided that
a) the first electronic device sends a request, in particular a communication request, to the second electronic device; and/or
b) the second electronic device sends a request, in particular a communication request, to the first electronic device.

The request, in particular the communication request, is, for example, an activation signal.

A respective electronic device sends the request, in particular the communication request, to the respective other electronic device preferably automatically.

In one embodiment of the method, it is provided that the encrypted device data set of an electronic device is stored in the respective electronic device, preferably in a data storage device of the respective electronic device.

The first electronic device and/or the second electronic device preferably each comprise a data storage device, for example a memory chip.

In one embodiment of the method, it is provided that
a) the second electronic device sends the encrypted device data set to the first electronic device, preferably after receiving a request from the first electronic device, in particular after receiving a communication request from the first electronic device; and/or
b) the first electronic device sends the encrypted device data set to the second electronic device, preferably after receiving a request from the second electronic device, in particular after receiving a communication request from the second electronic device.

In one embodiment of the method, it is provided that the encrypted device data set of a respective electronic device is stored in a computer network, preferably in one or more data storage devices of a computer network.

The computer network is, for example, a public computer network.

It may be advantageous if the computer network is connected to the internet.

The computer network is, for example, a public cloud.

In one embodiment of the method, it is provided that the encrypted device data set of a respective electronic device is stored in a distributed ledger, for example in the blockchain.

Preferably, the encrypted device data set of a respective electronic device can be stored in a tamper-proof manner by storing it in the distributed ledger, in particular in the blockchain.

Preferably, a decentralized provision of the encrypted device data sets of the electronic devices can be made possible by using a distributed ledger.

It can also be advantageous if resilience can be increased by using a distributed ledger.

In one embodiment of the method, it is provided that the encrypted device data set of a respective electronic device comprises the following device information:
information about a version of an operating system of the respective electronic device; and/or
information about a last update of an operating system of the respective electronic device; and/or
information about a configuration of the respective electronic device; and/or
information about hardware components installed in the respective electronic device; and/or
information about a time of manufacture, for example year of manufacture, of the respective electronic device; and/or
information about a number of the connections of the respective electronic device to other electronic devices in the past; and/or
a number of error messages of the respective electronic device in the past; and/or
information about possible connection types of the respective electronic device; and/or
information about an audit of the respective electronic device.

For example, it is conceivable that the encrypted device data set of a respective electronic device comprises information about a WLAN module installed in the electronic device.

The information about the hardware components installed in the respective electronic device preferably comprises information about a hardware component manufacturer and/or information about a hardware component time of manufacture.

The information about an audit of the respective electronic device comprises, for example, information about an audit time and/or information about the auditing body.

If an electronic device is an electronic monitoring device, the encrypted device data set will preferably comprise information about a number of alarms triggered by the electronic monitoring device in the past.

In one embodiment of the method, it is provided that the second electronic device sends identification information to the first electronic device after receiving a request from the first electronic device, in particular after receiving a communication request from the first electronic device, and/or that the first electronic device sends identification information to the second electronic device after receiving the request from the second electronic device, in particular after receiving the communication request from the second electronic device.

Alternatively, it is possible for a respective electronic device to transmit its identification information as a broadcast.

A respective electronic device can be identified in particular by means of the identification information.

In particular, an encrypted device data set of an electronic device, which is stored in a computer network, can be identified by means of the identification information of the respective electronic device and/or can be assigned to the respective electronic device.

In one embodiment of the method, it is provided that the identification information of a respective electronic device is encrypted, in particular by means of a public key infrastructure.

In one embodiment of the method, it is provided that a respective electronic device comprises identification information, the electronic devices mutually verifying their identities on the basis of the identification information.

For example, it is conceivable that the identification information of a respective electronic device comprises an unchangeable key, for example a hardware-generated or a software-generated key.

The identification information comprises, for example, a key which is permanently stored in a data storage device of the electronic device, for example in a read-only memory (ROM).

It may also be advantageous if the identification information of a respective electronic device comprises a physical unclonable function (PUF).

In one embodiment of the method, it is provided that an encrypted device data set of a respective electronic device, which is stored in a data storage device of the electronic device, comprises identification information of the respective electronic device; and/or that an encrypted device data set of a respective electronic device, which is stored in a computer network, comprises identification information of the respective electronic device.

For example, it is conceivable that an encrypted device data set of a respective electronic device stored in a data storage device of the electronic device comprises only the identification information of the respective electronic device.

In one embodiment of the method, it is provided that
a) an identity of the second electronic device is verified by the first electronic device by the first electronic device in each case performing computing operations on the encrypted device data sets of the second electronic device, which are stored in the data storage device of the second electronic device and in the computer network, and comparing the encrypted device data sets of the second electronic device; and/or
b) an identity of the first electronic device is verified by the second electronic device by the second electronic device in each case performing computing operations on the encrypted device data sets of the first electronic device, which are stored in the data storage device of the first electronic device and in the computer network, and in the process comparing the encrypted device data sets of the first electronic device.

In the performance of the computing operations, it is preferably determined whether the identification information of the respective electronic device, which is stored in the data storage device of the respective electronic device, matches the identification information of the respective electronic device stored in the computer network.

Preferably, by comparison of the encrypted device data sets and/or by determining a match of the identification information, it is determined whether the identity of a respective electronic device is true and/or correct.

In particular, an electronic device can thereby be prevented from displaying a false identity to another electronic device.

In one embodiment of the method, it is provided that
a) the first electronic device carries out computing operations on the encrypted device data set of the second electronic device and thereby determines the security data of the second electronic device; and/or
b) the second electronic device carries out computing operations on the encrypted device data set of the first electronic device and thereby determines the security data of the first electronic device.

It may be advantageous if the first electronic device and/or the second electronic device each comprise a data processing device, for example a microprocessor.

For example, it is conceivable that the first electronic device and/or the second electronic device each comprise an integrated circuit, wherein the respective integrated circuit of the first electronic device and/or of the second electronic device comprises the data storage device and the data processing device.

Preferably, an integrated circuit of the first electronic device and/or of the second electronic device each comprises a microprocessor and a memory chip.

The data processing device of the first electronic device is preferably configured and/or designed in such a way that the data processing device of the first electronic device carries out computing operations on the encrypted device data set of the second electronic device and thereby determines the security data of the second electronic device.

It can also be advantageous if the data processing device of the second electronic device is preferably configured and/or designed in such a way that the data processing device of the second electronic device carries out computing operations on the encrypted device data set of the first electronic device and in the process determines the security data of the first electronic device.

In one embodiment of the method, it is provided that
a) the first electronic device carries out the computing operations on the encrypted device data set of the second electronic device without the first electronic device being able to read in plain text the encrypted device data set of the second electronic device and/or without the first electronic device being able to decrypt the encrypted device data set of the second electronic device; and/or
b) the second electronic device carries out the computing operations on the encrypted device data set of the first electronic device without the second electronic device being able to read in plain text the encrypted device data set of the first electronic device and/or without the second electronic device being able to decrypt the encrypted device data set of the first electronic device.

In one embodiment of the method, it is provided that the security data comprise one or more security code values.

For example, it is conceivable for the security data to comprise information about a security state of a respective electronic device.

In one embodiment of the method, it is provided that a security state of a respective electronic device is divided into a plurality of security levels.

It may be advantageous if a respective electronic device is designed to determine the security state of a further electronic device.

In one embodiment of the method, it is provided that the security levels of a respective electronic device comprise the following:
Security Level I (communication with the respective electronic device is completely secure); and/or
Security Level II (communication with the respective electronic device is only partially secure); and/or
Security Level III (communication with the respective electronic device is entirely insecure).

In one embodiment of the method, it is provided that a communication connection between two or more than two electronic devices is established depending on the respective security state of a respective electronic device and/or depending on a respective security level.

For example, it is conceivable for the first electronic device to establish an unrestricted communication connection with the second electronic device when the second electronic device has a security state of Security Level I and/or for the second electronic device to establish an unrestricted communication connection with the first electronic device when the first electronic device has a security state of Security Level I.

In one embodiment of the method, it is provided that the first electronic device and the second electronic device establish a direct and unrestricted communication connection if
a) a security state of the second electronic device determined by the first electronic device on the basis of the encrypted device data set of the second electronic device matches a security state of the second electronic device prespecified for the unrestricted communication connection; and/or
b) a security state of the first electronic device determined by the second electronic device on the basis of the encrypted device data set of the first electronic device matches a security state of the first electronic device prespecified for the unrestricted communication connection.

Preferably, a security state of the second electronic device prespecified for the unrestricted communication connection is stored in a data storage device of the first electronic device.

A security state of the first electronic device prespecified for the unrestricted communication connection is preferably stored in a data storage device of the second electronic device.

It can also be advantageous if the first electronic device establishes only a restricted communication connection with the second electronic device when the second electronic device has a security state of Security Level II and/or if the second electronic device establishes only a restricted communication connection with the first electronic device when the first electronic device has a security state of Security Level II.

Preferably, the first electronic device does not establish a communication connection with the second electronic device when the second electronic device has a security state of Security Level III.

Alternatively or additionally, it is conceivable that the first electronic device, in the event that the second electronic device has a security state of Security Level III, establishes a communication connection with the second electronic device only via a firewall.

It can also be advantageous if the second electronic device does not establish a communication connection with the first electronic device when the second electronic device has a security state of Security Level III.

Alternatively or additionally, it is conceivable that the second electronic device, in the event that the first electronic device has a security state of Security Level III, establishes a communication connection with the first electronic device only via a firewall.

If a respective electronic device has a security state of Security Level III, the respective electronic device can preferably be updated, for example by updating an operating system of the respective electronic device and/or by exchanging a communication module of the respective electronic device.

In one embodiment of the method, it is provided that
a) the first electronic device establishes the communication connection with the second electronic device only when one or more security code values of the security data of the second electronic device exceed a prespecified limit value; and/or
b) the second electronic device establishes the communication connection with the first electronic device only when one or more security code values of the security data of the first electronic device exceed a prespecified limit value.

For example, it is conceivable that a common security code value is determined from the security data of the second electronic device, in particular from a plurality of security code values of the security data of the second electronic device, and/or that a common security code value is determined from the security data of the first electronic device, in particular from a plurality of security code values of the security data of the first electronic device.

The common security code value preferably reflects a trustworthiness of the respective electronic device.

The common security code value is in particular a “trust score” value.

In one embodiment of the method, it is provided that the first and the second electronic devices only establish the communication connection with one another when a security state of the second electronic device determined by the first electronic device and a security state of the first electronic device determined by the second electronic device have a prespecified security state.

Preferably, the first and the second electronic device must trust one another in order to establish a communication connection with one another.

In one embodiment of the method, it is provided that the prespecified security state of the first electronic device and of the second electronic device has a Security Level I (communication with the respective electronic device is completely secure) and/or a Security Level II (communication with the respective electronic device is only partially secure).

In one embodiment of the method, it is provided that the first and the second electronic devices only establish the communication connection with one another when a security state of the second electronic device determined by the first electronic device and a security state of the first electronic device determined by the second electronic device are identical.

In particular, in this case the first electronic device and the second electronic device have an identical security level.

In one embodiment of the method, it is provided that the encrypted device data sets of the electronic devices are updated, in particular encrypted device data sets of the electronic devices stored in a computer network.

In one embodiment of the method, it is provided that the following device information is updated when the encrypted device data set of a respective electronic device is updated:
a version of an operating system of the respective electronic device; and/or
a configuration of the respective electronic device; and/or
a number of the connections of the respective electronic device to other electronic devices in the past; and/or
a number of error messages of the respective electronic device in the past; and/or
a number of alarms triggered by the electronic monitoring device in the past; and/or
information about an audit of the respective electronic device.

Preferably, the updated device information of the updated device data sets is taken into account when determining the security data.

If the electronic device has triggered a large number of alarms in the past and/or if the electronic device has triggered a large number of error messages in the past, a security state of a less secure security level will be determined for example when determining the security data.

For example, it is conceivable that an intelligent fire detector, which has triggered numerous error messages and/or numerous alarms in the past, will be less trusted and a security state with a Security Level II or with a Security Level III will be determined.

For example, it is conceivable that the encrypted device data sets of the electronic devices are updated at regular time intervals.

If the encrypted device data sets of the electronic devices are updated at regular time intervals, device information of encrypted device data sets stored in a computer network may deviate from the actual device information of the respective electronic device, for example if an updating of an operating system of the respective electronic device has not been reported to the computer network.

It may be advantageous if the encrypted device data sets of the electronic devices are always updated when a version of an operating system of the respective electronic device and/or a configuration of the respective electronic device and/or a number of the connections of the respective electronic device with other electronic devices changes.

It may also be advantageous if the encrypted device data set of an electronic device is stored in a data storage device of the electronic device only during manufacture of the electronic device.

The encrypted device data set is then preferably not updated. For example, it is conceivable that such an electronic device is a fire detector, wherein an encrypted device data set is stored in a data storage device of the fire detector only during the manufacture thereof.

In one embodiment of the method, it is provided that the encrypted device data sets of the electronic devices are updated when an item of device information in an encrypted device data set is changed.

In one embodiment of the method, it is provided that the encrypted device data sets of the electronic devices are updated at regular time intervals.

The present invention further relates to a system for communication between electronic devices.

The present invention is based on the further object of providing a system for communication between electronic devices, by means of which electronic devices can communicate easily and securely with one another.

This object is achieved according to the invention by a system for communication between electronic devices having the features of claim 29.

The system is particularly suitable for carrying out the method according to the invention.

The system preferably comprises the following:
a first electronic device;
a second electronic device, wherein the first and second electronic devices are designed and/or configured to carry out the method according to the invention.

The method according to the invention for communication between electronic devices preferably comprises one or more of the features and/or advantages described in connection with the system according to the invention for communication between electronic devices.

The system for communication between electronic devices according to the invention preferably further comprises individual or several of the features and/or advantages described in connection with the method according to the invention for communication between electronic devices.

The method according to the invention for communication between electronic devices and/or the system according to the invention for communication between electronic devices can be used, for example, in the following fields of application: smart homes; the smart city; autonomous driving and/or in the healthcare sector.

In one embodiment of the system, it is provided that the first electronic device and the second electronic device are motor vehicles or control devices of motor vehicles.

Preferably, the first electronic device (control device of a motor vehicle) and the second electronic device (control device of a motor vehicle) can, after establishing a communication connection, exchange trustworthy data about a traffic status, for example a current traffic volume.

In one embodiment of the system, it is provided that the first electronic device is a control device of a motor vehicle, the second electronic device being a traffic light.

Once a communication connection has been established, the first electronic device (control device of a motor vehicle) and the second electronic device (traffic light) can preferably exchange trustworthy data about a traffic light status (green, amber, red) of the second electronic device (traffic light).

In one embodiment of the system, it is provided that an electronic device is an electronic monitoring device, for example a fire detector, a heat cost allocator and/or a water meter.

Furthermore, it is conceivable, for example, for a respective electronic device to be a device from the “smart home” sector, for example an intelligent light switch, an intelligent roller shutter controller, an intelligent heating thermostat, an intelligent surveillance camera, an intelligent door lock and/or an intelligent fire detector.

It can also be advantageous if an electronic device is an electronic device from the field of medical technology, for example a pacemaker or a vital data monitor of a patient monitoring system.

With a vital data monitor of a patient monitoring system, vital parameters of a patient can preferably be determined, for example heart rhythm, heart rate, blood pressure, oxygen saturation and/or body temperature.

Further preferred features and/or advantages of the invention form the subject matter of the following description and the drawings illustrating exemplary embodiments.

### BRIEF DESCRIPTION OF THE DRAWINGS

FIG. 1 is a schematic representation of a first electronic device and a second electronic device, wherein encrypted device data sets of the electronic devices are each stored in an electronic device and wherein the first electronic device and the second electronic device establish a communication connection;

FIG. 2 is a schematic representation of an encrypted device data set of an electronic device from FIG. 1;

FIG. 3 is a schematic representation of a method sequence for establishing a communication connection between the first electronic device and the second electronic device from FIG. 1;

FIG. 4 is a schematic view of a further method sequence for establishing a communication connection between the first electronic device and the second electronic device from FIG. 1;

FIG. 5 is a schematic representation of a first electronic device and a second electronic device, wherein encrypted device data sets of the electronic devices are stored in a computer network;

FIG. 6 is a schematic representation of a first electronic device and a second electronic device, wherein encrypted device data sets of the electronic devices are stored in a computer network and wherein identification information of the respective electronic device is encrypted;

FIG. 7 is a schematic representation of a method sequence for establishing a communication connection between the first electronic device and the second electronic device from FIG. 5 or 6;

FIG. 8 is a schematic representation of a further method sequence for establishing a communication connection between the first electronic device and the second electronic device from FIG. 5 or 6;

FIG. 9 is a schematic representation of a first electronic device and a second electronic device, wherein encrypted device data sets of the electronic devices are stored in a computer network and wherein an encrypted device data set stored in a respective electronic device comprises identification information;

FIG. 10 is a schematic representation of a method sequence for establishing a communication connection between the first electronic device and the second electronic device from FIG. 9; and

FIG. 11 is a schematic representation of a further method sequence for establishing a communication connection between the first electronic device and the second electronic device from FIG. 9.

The same or functionally equivalent elements are provided with the same reference signs in all figures.

### DETAILED DESCRIPTION OF THE DRAWINGS

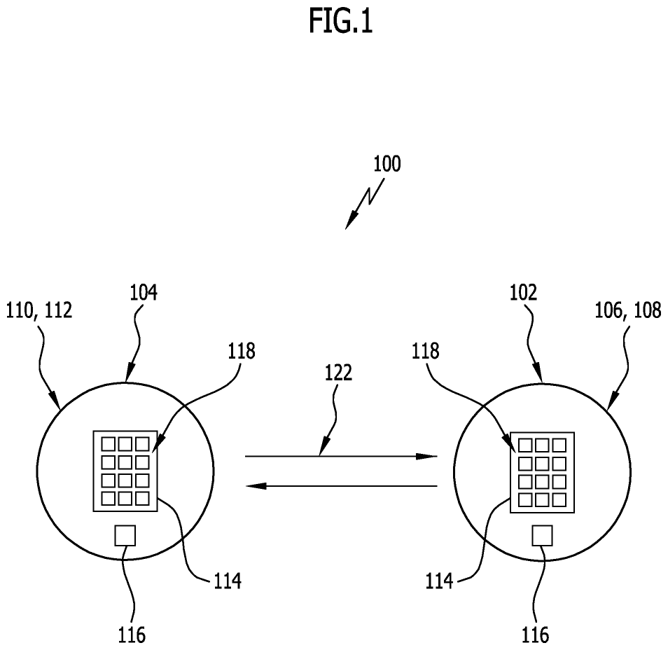

A system for communication between electronic devices, shown schematically in FIG. 1 and denoted as a whole by 100, preferably comprises a first electronic device 102 and a second electronic device 104.

The first electronic device 102 is, for example, an electronic device from the field of medical technology, for example a pacemaker 106 or a vital data monitor 108 of a patient monitoring system (not shown in more detail).

The second electronic device 104 can also be, for example, an electronic device from the field of medical technology, for example a control unit 110 for setting up a pacemaker 106 or a central unit 112 of a patient monitoring system.

The central unit 112 comprises, for example, a screen on which vital parameters of a patient can be displayed, and which are capturable by means of a vital data monitor 108.

The first electronic device 102 and the second electronic device 104 preferably each comprise a data storage device 114, for example a memory chip.

It may be advantageous if the first electronic device 102 and the second electronic device 104 each comprise a data processing device 116, for example a microprocessor.

The first electronic device 102 and the second electronic device 104 each comprise an integrated circuit, for example, the respective integrated circuit of the respective electronic device 102, 104 comprising the data storage device 114 and the data processing device 116.

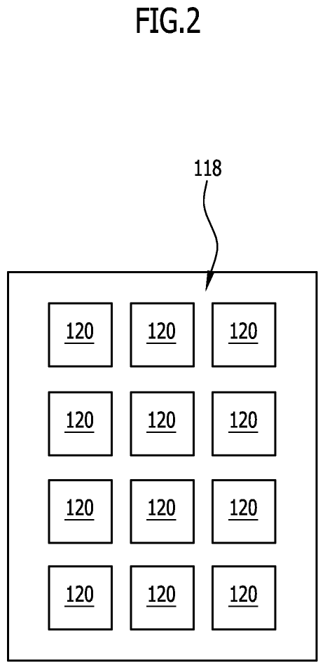

The first electronic device 102 and/or the second electronic device 104 preferably each comprise an encrypted device data set 118, which is shown, for example, in FIG. 2.

In the embodiment of the system 100 for communication between electronic devices shown in FIG. 1, the encrypted device data set 118 is stored in the respective electronic device 102, 104, preferably in the data storage device 114 of the respective electronic device 102, 104.

The encrypted device data set 118 of the electronic devices 102, 104 preferably comprises device information 120 about a respective electronic device 102, 104.

For example, it is conceivable that the encrypted device data set 118 of a respective electronic device 102, 104 comprises the following device information 120:
information about a version of an operating system of the respective electronic device 102, 104; and/or
information about a last update of an operating system of the respective electronic device 102, 104; and/or
information about a configuration of the respective electronic device 102, 104; and/or
information about hardware components installed in the respective electronic device 102, 104; and/or
information about a time of manufacture, for example year of manufacture, of the respective electronic device 102, 104; and/or
information about a number of the connections of the respective electronic device 102, 104 to other electronic devices in the past; and/or
a number of error messages of the respective electronic device 102, 104 in the past; and/or
information about possible connection types of the respective electronic device 102, 104; and/or
information about an audit of the respective electronic device 102, 104.

For example, it is conceivable that the encrypted device data set 118 of a respective electronic device 102, 104 comprises information about a WLAN module installed in the electronic device 102, 104.

Preferably, the information about the hardware components installed in the respective electronic device 102, 104 comprises information about a hardware component manufacturer and/or information about a hardware component time of manufacture.

The information about an audit of the respective electronic device 102, 104 comprises, for example, information about an audit time and/or information about the auditing body.

It may be advantageous if the encrypted device data set 118 of an electronic device 102, 104 is stored in the data storage device 114 of the electronic device 102, 104 only during manufacture of the electronic device 102, 104. The encrypted device data set 118 is then preferably not updated.

The first electronic device 102 communicates with the second electronic device 104 preferably only under certain conditions.

If the first electronic device 102 is a pacemaker 106 and if the second electronic device 104 is a control device 110, it can preferably be ensured for a patient that the first electronic device 102, in particular the pacemaker 106, is not infected with malware.

If the first electronic device 102 is a vital data monitor 108 of a patient monitoring system and if the second electronic device 104 is a central unit 112 of a patient monitoring system, it can preferably be ensured that no incorrect vital parameters of a patient are displayed on the central unit 112 of the patient monitoring system. Preferably, in this context incorrect treatment of the patient due to incorrectly displayed vital parameters can be prevented.

Preferably, the first electronic device 102 and the second electronic device 104 must trust one another in order to establish a communication connection 122.

The establishment of a communication connection 122 between the first electronic device 102 and the second electronic device 104 is carried out in the embodiment of a system 100 for communication between electronic devices, which is shown in FIG. 1, preferably as follows:

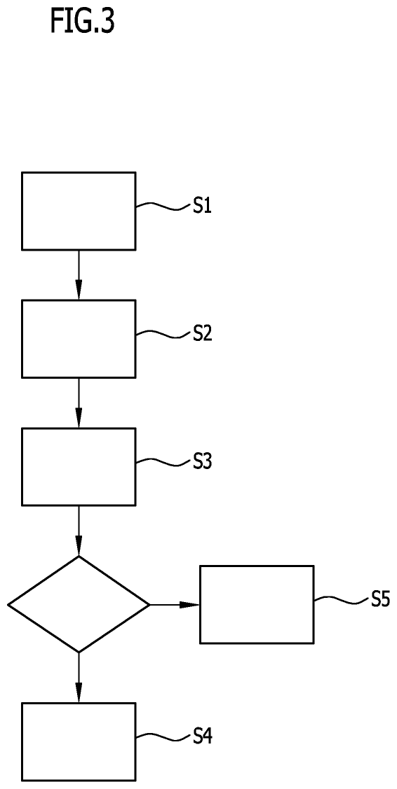

In a first step S1, the first electronic device 102 preferably sends a request to the second electronic device 104, in particular a communication request (cf. FIG. 3).

The request, in particular the communication request, is, for example, an activation signal.

In a second step S2, the second electronic device 104 preferably sends the encrypted device data set 118 to the first electronic device 102, in particular after receiving the request from the first electronic device 102.

Alternatively, in a first step S1, the second electronic device 104 preferably sends a request, in particular a communication request, to the first electronic device 102.

In this case, the first electronic device 102 sends the encrypted device data set 118 preferably in a second step S2 to the second electronic device 104, preferably after receiving the request from the second electronic device 104.

A respective electronic device 102, 104 sends the request, in particular the communication request, to the respective other electronic device 102, 104 in the first step S1, preferably automatically.

In a third step S3, the first electronic device 102 preferably determines security data of the second electronic device 104 on the basis of the encrypted device data set 118 of the second electronic device 118.

In the third step S3, the first electronic device 102 preferably carries out computing operations on the encrypted device data set 118 of the second electronic device 104 and while doing so determines the security data of the second electronic device 104.

The data processing device 116 of the first electronic device 102 is here preferably configured and/or designed in such a way that the data processing device 116 of the first electronic device 102 carries out computing operations on the encrypted device data set 118 of the second electronic device 104 and while doing so determines the security data of the second electronic device 104.

The first electronic device 102 carries out the computing operations on the encrypted device data set 118 of the second electronic device 104 in the third step S3 in particular without the first electronic device 102 being able to read in plain text the encrypted device data set 118 of the second electronic device 104 and/or without the first electronic device 102 being able to decrypt the encrypted device data set 118 of the second electronic device 104.

It can also be advantageous if the second electronic device 104 determines security data of the first electronic device 102 in a third step S3 on the basis of the encrypted device data set 118 of the first electronic device 102.

In the third step S3, the second electronic device 104 preferably carries out computing operations on the encrypted device data set 118 of the first electronic device 102 and while doing so determines the security data of the first electronic device 102.

The data processing device 116 of the second electronic device 104 is preferably configured and/or designed in such a way that the data processing device 116 of the second electronic device 104 carries out computing operations on the encrypted device data set 118 of the first electronic device 102 and while doing so determines the security data of the first electronic device 102.

The second electronic device 104 preferably carries out the computing operations on the encrypted device data set 118 of the first electronic device 102 in the third step S3 without the second electronic device 104 being able to read in plain text the encrypted device data set 118 of the first electronic device 102 and/or without the second electronic device 104 being able to decrypt the encrypted device data set 118 of the first electronic device 102.

In a fourth step S4, the first electronic device 102 preferably establishes a communication connection 122 with the second electronic device 104 if security data of the second electronic device 104 fall within a prespecified value range and/or exceed a prespecified limit value.

It can also be advantageous if, in a fourth step S4, the second electronic device 104 establishes a communication connection 122 with the first electronic device 102 if security data of the first electronic device 102 fall within a prespecified value range and/or exceed a prespecified limit value.

The communication connection 122 is, for example, a peer-to-peer (P2P) communication connection, preferably a wireless communication connection.

The wireless communication connection preferably comprises a communication according to one or more of the following communication standards:
a mobile radio standard;
a WLAN (wireless local area network) standard;
a long-range wide area network (LoRaWAN) standard;
a narrowband Internet of Things (NB-IoT) standard;
a Bluetooth standard;
a Zigbee standard;
an NFC standard.

The security data of a respective electronic device 102, 104 include, for example, one or more security code values.

For example, it is conceivable that the security data of the electronic devices 102, 104 comprise information about a security state of a respective electronic device 102, 104.

In this case, a respective electronic device 102, 104 is preferably designed to determine the security state of a further electronic device 102, 104.

It may be advantageous in particular if the data processing device 116 of a respective electronic device 102, 104 is designed to determine the security state of a respective other electronic device 102, 104.

For example, the data processing device 116 of the first electronic device 102 is designed to determine the security state of the second electronic device 104.

Preferably, the data processing device 116 of the second electronic device 104 is designed to determine the security state of the first electronic device 102.

A security state of a respective electronic device 102, 104 is preferably divided into a plurality of security levels.

The security levels of a respective electronic device 102, 104 include, for example:
Security Level I (communication with the respective electronic device is completely secure); and/or
Security Level II (communication with the respective electronic device is only partially secure); and/or
Security Level III (communication with the respective electronic device is entirely insecure).

Preferably, the establishment of the communication connection 122 between the first electronic device 102 and the second electronic device 104 takes place depending on the respective security state of a respective electronic device 102, 104 and/or depending on a respective security level.

In the embodiment of a method for establishing a communication connection 122 shown in FIG. 3, the first electronic device 102, in the fourth step S4, preferably establishes an unrestricted communication connection with the second electronic device 104 if the second electronic device 104 has a security state of Security Level I.

It can also be advantageous if the second electronic device 104, in the fourth step S4, establishes an unrestricted communication connection with the first electronic device 102 if the first electronic device 102 has a security state of Security Level I.

The first electronic device 102 and the second electronic device 104 establish the communication connection 122 with one another in particular only if a security state of the second electronic device 104 determined by the first electronic device 102 and a security state of the first electronic device 102 determined by the second electronic device 104 have a prespecified security state.

The first electronic device 102 and the second electronic device 104, in particular, establish a direct and unrestricted communication connection if a security state of the second electronic device 104 determined by the first electronic device 102 on the basis of the encrypted device data set of the second electronic device 104 matches a security state of the second electronic device 104 prespecified for the unrestricted communication connection and/or if a security state of the first electronic device 102 determined by the second electronic device 104 on the basis of the encrypted device data set of the first electronic device 102 matches a security state of the first electronic device 102 prespecified for the unrestricted communication connection.

A security state of the first electronic device 102 prespecified for the unrestricted communication connection 122 is preferably stored in the data storage device 114 of the second electronic device 104.

Preferably, a security state of the second electronic device 104 prespecified for the unrestricted communication connection 122 is stored in the data storage device 114 of the first electronic device 102.

The electronic devices 102, 104 establish a communication connection 122 with one another in particular only if a security state of the second electronic device 104 determined by the first electronic device 102 and a security state of the first electronic device 102 determined by the second electronic device 104 are identical.

The electronic devices 102, 104 preferably do not establish a communication connection 122 with the respective other electronic device 102, 104 (step S5) if the respective other electronic device 102, 104 has a security state of Security Level III.

As an alternative to this, it is conceivable that the electronic devices 102, 104, in the event that the respective other electronic device 102, 104 has a security state of Security Level III, establish a communication connection 122 with the respective other electronic device 102, 104 only via a firewall.

If a respective electronic device 102, 104 has a security state of Security Level III, the respective electronic device 102, 104 can preferably be updated, for example by updating an operating system of the electronic device 102, 104 and/or by exchanging a communication module (not shown) of the respective electronic device 102, 104.

The first electronic device 102 preferably only establishes the communication connection 122 with the second electronic device 104 if one or more security code values of the security data of the second electronic device 104 exceed a prespecified limit value.

It can also be advantageous if the second electronic device 104 only establishes the communication connection 122 with the first electronic device 102 if one or more security code values of the security data of the first electronic device 102 exceed a prespecified limit value.

For example, it is conceivable that a common security code value is determined from the security data of the second electronic device 104, in particular from a plurality of security code values of the security data of the second electronic device 104, and/or that a common security code value is determined from the security data of the first electronic device 102, in particular from a plurality of security code values of the security data of the first electronic device 102.

The common security code value preferably reflects a trustworthiness of the respective electronic device.

The common security code value is in particular a “trust score” value.

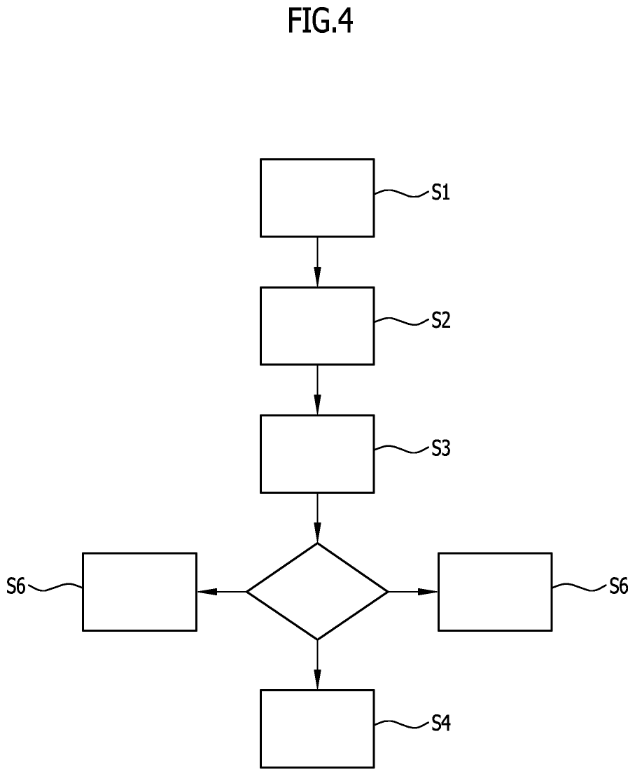

An embodiment of a method for communication between electronic devices shown in FIG. 4 essentially differs from the embodiment of a method for communication between electronic devices shown in FIG. 3 in that the electronic devices 102, 104 can also establish a restricted communication connection 122 (step S6).

If the second electronic device 104 has a security state of Security Level II, the first electronic device 102 will preferably establish only a restricted communication connection 122 with the second electronic device 104.

Preferably, the second electronic device 104 also establishes only a restricted communication connection 122 with the first electronic device 102 if the first electronic device 102 has a security state of Security Level II.

Otherwise, the embodiment of a method for communication between electronic devices shown in FIG. 4 corresponds to the embodiment of a method for communication between electronic devices shown in FIG. 3, so that reference is made in this respect to the above description thereof.

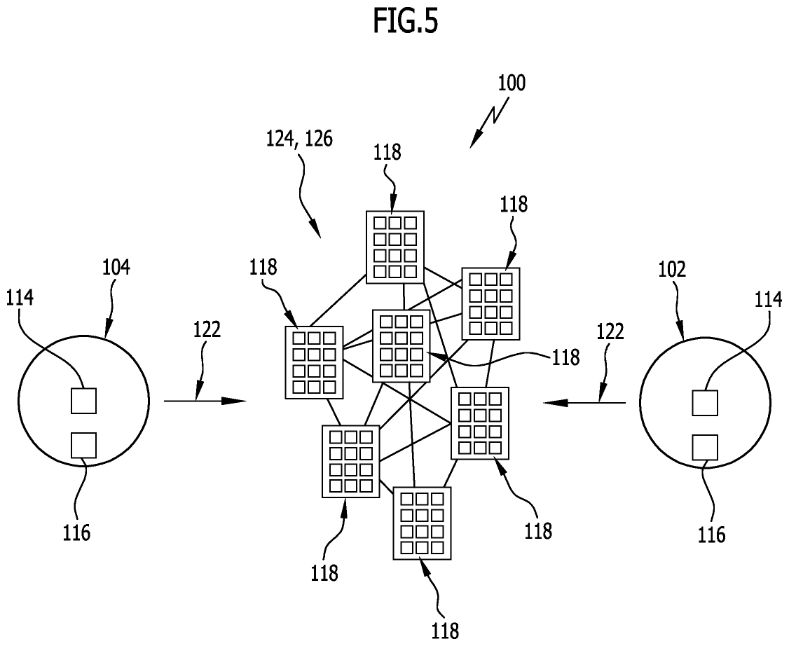

An embodiment of a system 100 for communication between electronic devices shown in FIG. 5 essentially differs from the embodiment of a system 100 for communication between electronic devices shown in FIG. 1 in that the encrypted device data set 118 of a respective electronic device 102, 104 is stored in a computer network 124, preferably in one or more data storage devices of a computer network 124, not shown in the drawings.

The computer network 124 is, for example, a public computer network.

It may be advantageous if the computer network 124 is connected to the internet.

The computer network 124 is, for example, a public cloud.

It may be advantageous, in particular, if the encrypted device data set 118 of a respective electronic device 102, 104 is stored in a distributed ledger 126, for example in the blockchain.

Preferably, the encrypted device data set 118 of a respective electronic device 102, 104 can be stored in a tamper-proof manner by storing the same in the distributed ledger 126, in particular in the blockchain.

Preferably, a decentralized provision of the encrypted device data sets 118 of the electronic devices 102, 104 can be made possible by using a distributed ledger 126.

It can also be advantageous if resilience can be increased by using a distributed ledger 126.

In the embodiment of a system 100 for communication between electronic devices shown in FIG. 5, the encrypted device data sets 118 of the electronic devices 102, 104 stored in the computer network 124 are preferably updated.

During updating of the encrypted device data set 118 of a respective electronic device 102, 104, the following device information is in particular updated:
a version of an operating system of the respective electronic device 102, 104; and/or
a configuration of the respective electronic device 102, 104; and/or
a number of the connections of the respective electronic device 102, 104 to other electronic devices 102, 104 in the past
a number of error messages of the respective electronic device 102, 104 in the past; and/or
a number of alarms triggered by the electronic device 102, 104 in the past;
and/or
information about an audit of the respective electronic device 102, 104.

Preferably, the updated device information is taken into account for the updated device data sets 118 when determining the security data.

If an electronic device 102, 104 has triggered a large number of alarms in the past and/or if the electronic device 102, 104 has triggered a large number of error messages in the past, a security state of a less secure security level is determined when determining the security data, for example.

For example, it is conceivable that an intelligent fire detector, which has triggered numerous error messages and/or numerous alarms in the past, will be less trusted and a security state with a Security Level II or with a Security Level III will be determined.

It is conceivable, for example, for the encrypted device data sets 118 of the electronic devices 102, 104 to be updated at regular time intervals.

If the encrypted device data sets 118 of the electronic devices 102, 104 are updated at regular time intervals, device information of encrypted device data sets 124 stored in a computer network 124 can deviate from the actual device information of the respective electronic device 102, 104, for example if an updating of an operating system of the respective electronic device 102, 104 has not yet been reported to the computer network 124.

Alternatively or additionally to an updating of the encrypted device data sets 118 at regular time intervals, it is conceivable for the encrypted device data sets 118 of the electronic devices 102, 104 to be updated when an item of device information in an encrypted device data set 118 is changed.

It may be advantageous, for example, if the encrypted device data sets 118 of the electronic devices 102, 104 are always updated when a version of an operating system of the respective electronic device 102, 104 and/or a configuration of the respective electronic device 102, 104 and/or a number of the connections of the respective electronic device 102, 104 to other electronic devices 102, 104 changes.

In the embodiment of a system 100 for communication between electronic devices shown in FIG. 5, it can be provided that the first electronic device 102 and the second electronic device 104 are motor vehicles or control devices of motor vehicles.

Preferably, the first electronic device 102 and the second electronic device 104 can, after establishing a communication connection 122, exchange trustworthy data about a traffic status, for example a current traffic volume.

It can also be advantageous if the first electronic device 102 is a control device of a motor vehicle and if the second electronic device 104 is a traffic light.

Once a communication connection 122 has been established, the first electronic device 102 and the second electronic device 104 can preferably exchange trustworthy data about a traffic light status (green, amber, red) of the second electronic device 104.

In the embodiment 100 illustrated in FIG. 5 of a system 100 for communication between electronic devices, identification information is preferably stored in the data storage device 114 of a respective electronic device 102, 104, by means of which identification information a respective electronic device 102, 104 is preferably identifiable.

An encrypted device data set 118 of an electronic device 102, 104, which is stored in the computer network 124, is preferably identifiable by means of the identification information of the respective electronic device 102, 104 and can be assigned to the respective electronic device 102, 104.

Otherwise, the embodiment of a system 100 for communication between electronic devices shown in FIG. 5 corresponds in terms of structure and function to the embodiment of a system 100 for communication between electronic devices shown in FIG. 1, so that reference is made in this respect to the above description thereof.

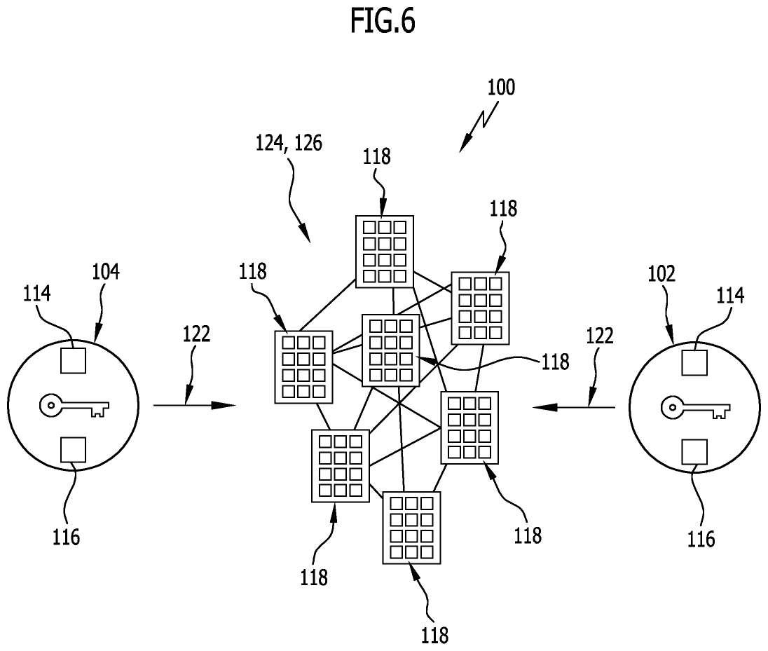

An embodiment of a system 100 for communication between electronic devices shown in FIG. 6 essentially differs from the embodiment of a system 100 for communication between electronic devices shown in FIG. 5 in that the identification information of a respective electronic device 102, 104 is encrypted, in particular by means of a public key infrastructure.

Otherwise, the embodiment of a system 100 for communication between electronic devices shown in FIG. 6 corresponds in terms of structure and function to the embodiment of a system 100 for communication between electronic devices shown in FIG. 5, so that reference is made in this respect to the above description thereof.

The establishment of a communication connection 122 between the first electronic device 102 and the second electronic device 104 is carried out in the embodiments of a system 100 for communication between electronic devices, which are illustrated in FIGS. 5 and 6, preferably as follows:

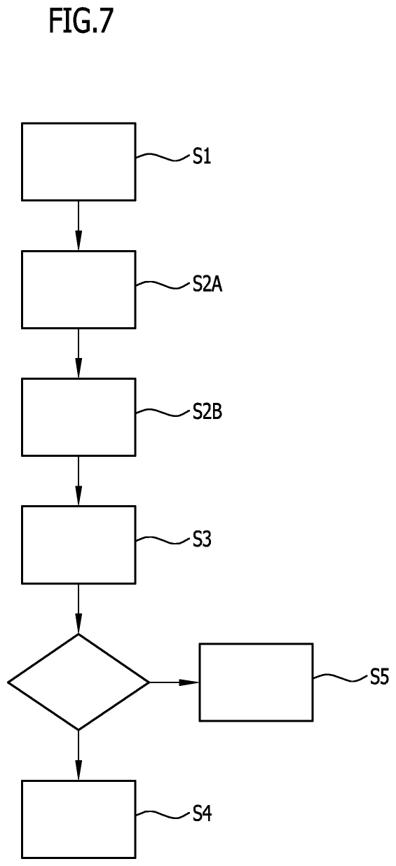

In a first step S1, the first electronic device 102 preferably sends a request, in particular a communication request, to the second electronic device 104 or vice versa (cf. FIG. 7).

After receiving the request from the first electronic device 102, in particular after receiving the communication request from the first electronic device 102, the second electronic device 104 preferably sends identification information to the first electronic device 102 (step S2A).

Alternatively, it is conceivable that the first electronic device 102 sends identification information to the second electronic device 104 (step S2A) after receiving the request from the second electronic device 104, in particular after receiving the communication request from the second electronic device 104.

Alternatively, it is possible for a respective electronic device 102, 104 to transmit its identification information as a broadcast.

On the basis of the received identification information, the first electronic device 102 preferably determines the encrypted device data set 118 of the second electronic device 104 and/or vice versa in a step S2B.

In a third step S3, the first electronic device 102 preferably determines security data of the second electronic device 104 or vice versa on the basis of the encrypted device data set 118 of the second electronic device 118.

The method steps S3 to S5 in the embodiment of a method for communication between electronic devices shown in FIG. 6 essentially correspond to the method steps S3 to S5 of the embodiment of a method for communication between electronic devices shown in FIG. 3, so that reference is made to the above description thereof.

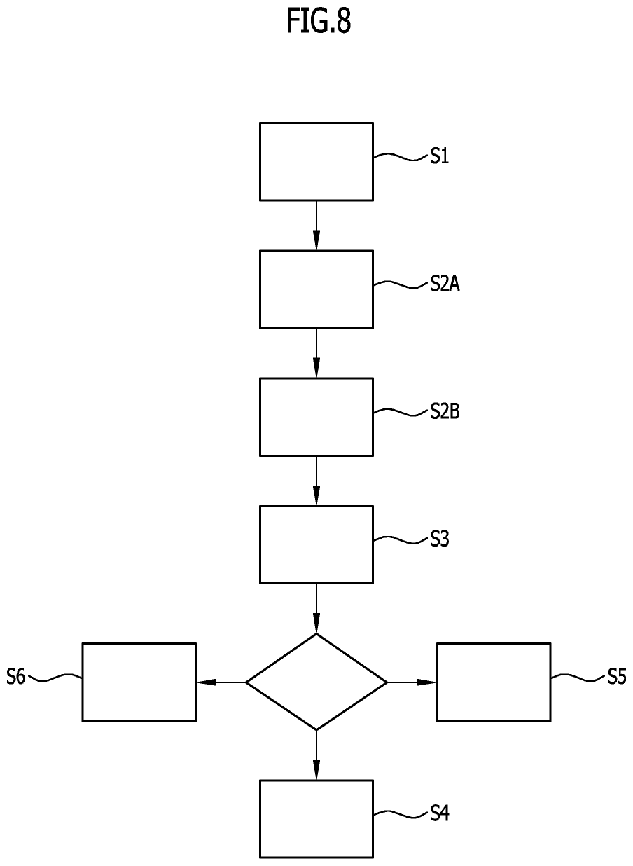

An embodiment of a method for communication between electronic devices shown in FIG. 8 essentially differs from the embodiment of a method for communication between electronic devices shown in FIG. 7 in that the electronic devices 102, 104 can also establish a restricted communication connection 122 (step S6).

If the second electronic device 104 has a security state of Security Level II, the first electronic device 102 will preferably establish only a restricted communication connection 122 with the second electronic device 104.

Preferably, the second electronic device 104 also establishes only a restricted communication connection 122 with the first electronic device 102 if the first electronic device 102 has a security state of Security Level II.

Otherwise, the embodiment of a method for communication between electronic devices shown in FIG. 8 corresponds to the embodiment of a method for communication between electronic devices shown in FIG. 7, so that reference is made in this respect to the above description thereof.

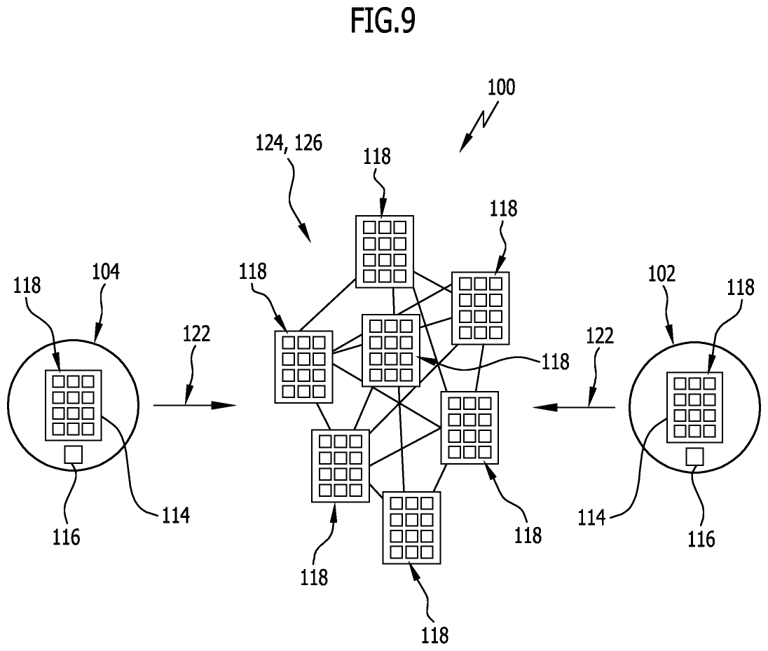

An embodiment of a system 100 for communication between electronic devices shown in FIG. 9 essentially differs from the embodiment of a system 100 for communication between electronic devices shown in FIG. 6 in that an encrypted device data set 118 is stored in a respective electronic device 102, 104, which comprises identification information of the respective electronic device.

Preferably, the encrypted device data set 118 of a respective electronic device 102, 104, which is stored in the computer network 124, also comprises identification information of the respective electronic device 102, 104.

The encrypted device data set 118 of a respective electronic device 102, 104 stored in the data storage device 114 of the electronic device 102, 104 comprises in particular only the identification information of the respective electronic device 102, 104.

In the embodiment of a system 100 for communication between electronic devices shown in FIG. 9, it can be provided, for example, that an electronic device 102, 104 is an electronic monitoring device, for example a fire detector, a heat cost allocator and/or a water meter.

Furthermore, it is conceivable, for example, for a respective electronic device 102, 104 to be a device from the “smart home” sector, for example an intelligent light switch, an intelligent roller shutter controller, an intelligent heating thermostat, an intelligent monitoring camera, an intelligent door lock and/or an intelligent fire detector.

Otherwise, the embodiment of a system 100 for communication between electronic devices shown in FIG. 9 corresponds in terms of structure and function to the embodiment of a system 100 for communication between electronic devices shown in FIG. 6, so that reference is made in this respect to the above description thereof.

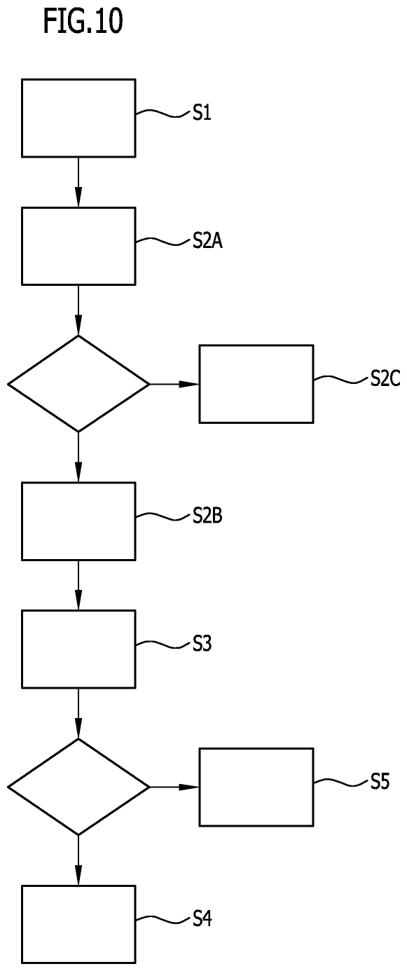

An embodiment of a method for communication between electronic devices shown in FIG. 10 essentially differs from the embodiment of a method for communication between electronic devices shown in FIG. 6 in that an identity of a respective electronic device 102, 104 in the embodiment of a system 100 for communication between electronic devices shown in FIG. 9 is verified by the respective other electronic device 102, 104.

In a first step S1, the first electronic device 102 preferably sends a request, in particular a communication request, to the second electronic device 104 or vice versa (cf. FIG. 7).

Upon receiving the request from the first electronic device 102, in particular after receiving the communication request from the first electronic device 102, the second electronic device 104 preferably sends to the first electronic device 102 the encrypted device data set 118 stored in the data storage device 114 of the second electronic device 104 (step S2A).

The identity of the second electronic device 104 is preferably verified by the first electronic device 102 by the first electronic device 102 carrying out computing operations on the encrypted device data sets 118 of the second electronic device 104 stored in the data storage device 114 of the second electronic device 104 and in the computer network 124, and during this comparing the encrypted device data sets 118 of the second electronic device 104.

Alternatively, it is conceivable that after receiving the request from the second electronic device 104, in particular after receiving the communication request from the second electronic device 104, the first electronic device 102 sends to the second electronic device 102 the encrypted device data set 118 stored in the data storage device 114 of the first electronic device 104 (step S2A).

The identity of the first electronic device 102 is verified by the second electronic device 104 in particular by the second electronic device 104 carrying out computing operations on the encrypted device data sets 118 of the first electronic device 102, which are stored in the data storage device 114 of the first electronic device 102 and in the computer network 124, and during this comparing the encrypted device data sets 118 of the first electronic device 102.

In the performance of the computing operations, it is preferably determined whether the identification information of the respective electronic device 102, 104 stored in the data storage device 114 of the respective electronic device 102, 104 matches the identification information of the respective electronic device 102, 104 stored in the computer network 124.

Preferably, by comparison of the encrypted device data sets 118 and/or by determining a match of the identification information it is determined whether the identity of a respective electronic device 102, 104 is true and/or correct.

In particular, an electronic device 102, 104 can thereby be prevented from displaying a false identity to another electronic device 102, 104.

If during verification of the identity of a respective electronic device 102, 104 it is determined that the identity of the respective electronic device is not correct or not true, the first electronic device 102 preferably determines the encrypted device data set 118 of the second electronic device 104 and/or vice versa in a step S2B.

If during verification of the identity of a respective electronic device 102, 104 it is determined that the identity of the respective electronic device is not correct or not true, preferably no communication connection is established and the method terminates in a step S2C.

In a third step S3, the first electronic device 102 preferably determines security data of the second electronic device 104 or vice versa on the basis of the encrypted device data set 118 of the second electronic device 118.

The method steps S3 to S5 in the embodiment of a method for communication between electronic devices shown in FIG. 10 essentially correspond to the method steps S3 to S5 of the embodiment of a method for communication between electronic devices shown in FIG. 6, so that reference is made to the above description thereof.

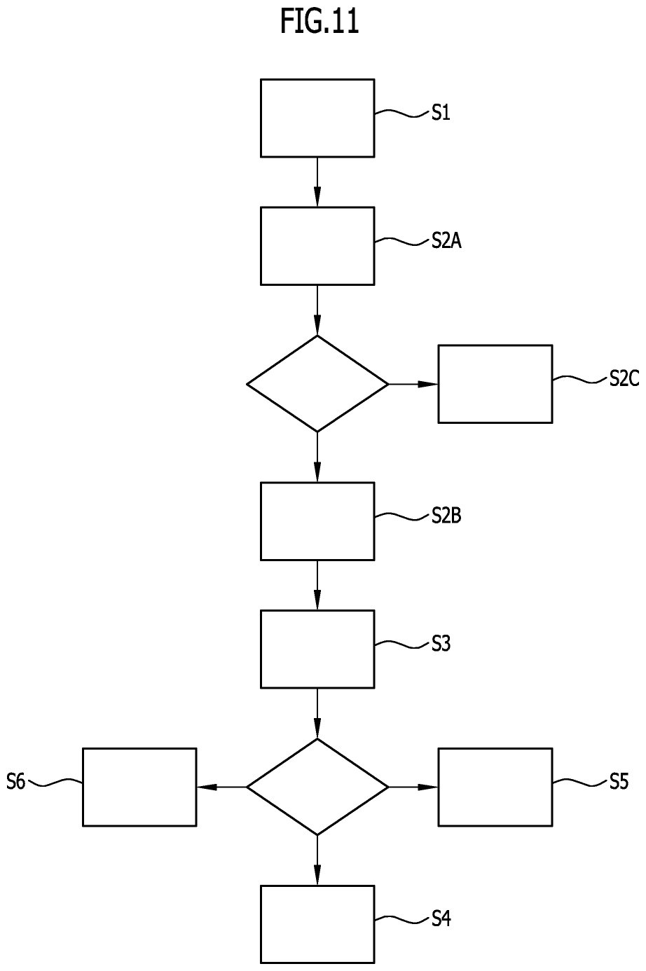

An embodiment of a method for communication between electronic devices shown in FIG. 11 essentially differs from the embodiment of a method for communication between electronic devices shown in FIG. 10 in that the electronic devices 102, 104 of the embodiment of a system 100 shown in FIG. 9 can also establish a restricted communication connection 122 for communication between electronic devices (step S6).

If the second electronic device 104 has a security state of Security Level II, the first electronic device 102 will preferably have only a restricted communication connection 122 with the second electronic device 104.

Preferably, the second electronic device 104 likewise establishes only a restricted communication connection 122 with the first electronic device 102 if the first electronic device 102 has a security state of Security Level II.

Otherwise, the embodiment of a method for communication between electronic devices shown in FIG. 11 corresponds in terms of structure and function to the embodiment of a method for communication between electronic devices shown in FIG. 10, so that reference is made in this respect to the above description thereof.

Overall, a system 100 and a method for communication between electronic devices can be provided by means of which electronic devices can communicate easily and securely with one another.

What is claimed is:

1. Method for communication between electronic devices, for example between two or more than two electronic devices, the method comprising:
providing a first electronic device;
providing a second electronic device, wherein
a) the first electronic device determines security data of the second electronic device on the basis of an encrypted device data set of the second electronic device; and/or
b) the second electronic device determines security data of the first electronic device on the basis of an encrypted device data set of the first electronic device.

2. Method according to claim 1, wherein
a) the first electronic device establishes a communication connection with the second electronic device when security data of the second electronic device lie within a prespecified value range and/or exceed a prespecified limit value; and/or
b) the second electronic device establishes a communication connection with the first electronic device when security data of the first electronic device lie within a prespecified value range and/or exceed a prespecified limit value.

3. Method according to claim 1, wherein
a) the first electronic device sends a request, in particular a communication request, to the second electronic device; and/or
b) the second electronic device sends a request, in particular a communication request, to the first electronic device.

4. Method according to claim 1, wherein the encrypted device data set of an electronic device is stored in the respective electronic device, preferably in a data storage device of the respective electronic device.

5. Method according to claim 4, wherein
a) the second electronic device sends the encrypted device data set to the first electronic device, preferably after receiving a request from the first electronic device, in particular after receiving a communication request from the first electronic device; and/or
b) the first electronic device sends the encrypted device data set to the second electronic device, preferably after receiving a request from the second electronic device, in particular after receiving a communication request from the second electronic device.

6. Method according to claim 1, wherein the encrypted device data set of a respective electronic device is stored in a computer network, preferably in one or more data storage devices of a computer network.

7. Method according to claim 6, wherein the encrypted device data set of a respective electronic device is stored in a distributed ledger, for example in the blockchain.

8. Method according to claim 1, wherein the encrypted device data set of a respective electronic device comprises the following device information:
information about a version of an operating system of the respective electronic device; and/or
information about a last update of an operating system of the respective electronic device; and/or
information about a configuration of the respective electronic device; and/or
information about hardware components installed in the respective electronic device; and/or
information about a time of manufacture, for example year of manufacture, of the respective electronic device; and/or
information about a number of the connections of the respective electronic device to other electronic devices in the past; and/or
a number of error messages of the respective electronic device in the past; and/or
information about possible connection types of the respective electronic device.

9. Method according to claim 1, wherein, after receiving a request from the first electronic device, in particular after receiving a communication request from the first electronic device, the second electronic device sends identification information to the first electronic device; and/or wherein the first electronic device sends identification information to the second electronic device after receiving the request from the second electronic device, in particular after receiving the communication request from the second electronic device.

10. Method according to claim 9, wherein the identification information of a respective electronic device is encrypted, in particular by means of a public key infrastructure.

11. Method according to claim 1, wherein a respective electronic device comprises identification information, the electronic devices mutually verifying their identity on the basis of the identification information.

12. Method according to claim 1, wherein an encrypted device data set of a respective electronic device stored in a data storage device of the electronic device comprises identification information of the respective electronic device, and/or wherein an encrypted device data set of a respective electronic device stored in a computer network comprises identification information of the respective electronic device.

13. Method according to claim 12, wherein
a) an identity of the second electronic device is verified by the first electronic device by the first electronic device carrying out computing operations on each of the encrypted device data sets of the second electronic device stored in the data storage device of the second electronic device and in the computer network, and comparing the encrypted device data sets of the second electronic device; and/or
b) an identity of the first electronic device is verified by the second electronic device by the second electronic device carrying out computing operations on each of the encrypted device data sets of the first electronic device stored in the data storage device of the first electronic device and in the computer network and comparing the encrypted device data sets of the first electronic device.

14. Method according to claim 1, wherein
a) the first electronic device carries out computing operations on the encrypted device data set of the second electronic device, in the process determining the security data of the second electronic device; and/or
b) the second electronic device carries out computing operations on the encrypted device data set of the first electronic device, in the process determining the security data of the first electronic device.

15. Method according to claim 1, wherein
a) the first electronic device carries out the computing operations on the encrypted device data set of the second electronic device without the first electronic device being able to read in plain text the encrypted device data set of the second electronic device and/or without the first electronic device being able to decrypt the encrypted device data set of the second electronic device; and/or
b) the second electronic device carries out the computing operations on the encrypted device data set of the first electronic device without the second electronic device being able to read in plain text the encrypted device data set of the first electronic device and/or without the second electronic device being able to decrypt the encrypted device data set of the first electronic device.

16. Method according to claim 1, wherein the security data comprises one or more security code values.

17. Method according to claim 1, wherein a security state of a respective electronic device is divided into a plurality of security levels.

18. Method according to claim 17, wherein the security levels of a respective electronic device comprise:
Security Level I (communication with the respective electronic device is completely secure); and/or
Security Level II (communication with the respective electronic device is only partially secure); and/or
Security Level III (communication with the respective electronic device is entirely insecure).

19. Method according to claim 17, wherein a communication connection between two or more than two electronic devices is established depending on the respective security state of a respective electronic device and/or depending on a respective security level.

20. Method according to claim 19, wherein the first electronic device and the second electronic device establish a direct and unrestricted communication connection when
a) a security state of the second electronic device determined by the first electronic device on the basis of the encrypted device data set of the second electronic device matches a security state of the second electronic device prespecified for the unrestricted communication connection; and/or
b) a security state of the first electronic device determined by the second electronic device on the basis of the encrypted device data set of the first electronic device matches a security state of the first electronic device prespecified for the unrestricted communication connection.

21. Method according to claim 2, wherein
a) the first electronic device establishes the communication connection with the second electronic device only when one or more security code values of the security data of the second electronic device exceed a prespecified limit value; and/or
b) the second electronic device establishes the communication connection with the first electronic device only when one or more security code values of the security data of the first electronic device exceed a prespecified limit value.

22. Method according to claim 2, wherein the first and second electronic devices establish the communication connection with one another only if a security state of the second electronic device determined by the first electronic device and a security state of the first electronic device determined by the second electronic device have a prespecified security state.

23. Method according to claim 22, wherein the prespecified security state of the first electronic device and of the second electronic device have a Security Level I (communication with the respective electronic device is completely secure) and/or a Security Level II (communication with the respective electronic device is only partially secure).

24. Method according to claim 22, wherein the first and second electronic devices establish the communication connection with one another only if a security state of the second electronic device determined by the first electronic device and a security state of the first electronic device determined by the second electronic device are identical.

25. Method according to claim 1, wherein the encrypted device data sets of the electronic devices are updated, in particular encrypted device data sets of the electronic devices stored in a computer network.

26. Method according to claim 25, wherein the following device information is updated when the encrypted device data set of a respective electronic device is updated:
a version of an operating system of the respective electronic device; and/or
a configuration of the respective electronic device; and/or
a number of the connections of the respective electronic device to other electronic devices (in the past; and/or
a number of error messages of the respective electronic device in the past; and/or
a number of alarms triggered by the electronic device in the past; and/or
information about an audit of the respective electronic device.

27. Method according to claim 25, wherein the encrypted device data sets of the electronic devices are updated when an item of device information in an encrypted device data set has changed.

28. Method according to claim 25, wherein the encrypted device data sets of the electronic devices are updated at regular time intervals.

29. System for communicating between electronic devices, for example between two electronic devices, in particular for carrying out the method according to claim 1, the system comprising:
a first electronic device;
a second electronic device,
wherein the first and second electronic devices are designed and/or configured to carry out the method according to claim 1.

30. System according to claim 29, wherein the first electronic device and the second electronic device are motor vehicles or control devices of motor vehicles.

31. System according to claim 29, wherein the first electronic device is a control device of a motor vehicle, the second electronic device being a traffic light.

32. System according to claim 29, wherein an electronic device is an electronic monitoring device, for example a fire detector, a heat cost allocator and/or a water meter.
